(19) United States
(12) Patent Application Publication
(10) Pub. No.: US 2012/0136489 A1
(43) Pub. Date: May 31, 2012

(54) RACK SERVER SYSTEM

(75) Inventors: Hao-Hao WANG, SHANGHAI (CN); Kang-Zhen LOU, SHANGHAI (CN); Xiao-Hua WANG, SHANGHAI (CN); Jian-Pei ZHANG, SHANGHAI (CN); Shen-Hsien LIU, TAIPEI CITY (TW)

(73) Assignee: INVENTEC CORPORATION, TAIPEI CITY (TW)

(21) Appl. No.: 13/014,728

(22) Filed: Jan. 27, 2011

(30) Foreign Application Priority Data
Nov. 30, 2010 (TW) 099141496

(51) Int. Cl. G05D 7/06

(52) U.S. Cl. 700/282

(57) ABSTRACT

A rack server system is provided. The rack server system includes a plurality of server modules, a plurality of fan modules, a rack management network and a rack management module. Each of the server modules comprises a baseboard management controller (BMC) to monitor and manage a work status of the corresponding server module. Each of the fan modules includes a plurality of fans. The rack management network is connected to the BMC of each server module. The rack management module receives the work status from the BMC of each server module through the rack management network to control and manage the server modules and to control speed of the fan modules.

### RELATED APPLICATIONS

This application claims priority to Taiwan Application Serial Number 099141496, filed Nov. 30, 2010, which is herein incorporated by reference.

### BACKGROUND

1. Field of Invention

The disclosure relates to a server architecture. More particularly, the disclosure relates to a rack server system.

2. Description of Related Art

Network is an indispensable tool in information communication and exchange in modern life. A server, which is an important tool for providing network services, needs to have a capability of processing a mass of data. Therefore, the server needs to be well designed in terms of data processing and heat dissipation capability so as to achieve the most effective control and management.

Typically, in the design of a common server system, all servers function individually. The sensor of the respective server controls a fan of the server to dissipate heat after sensing. However, this design method arranges more and more servers in one rack regardless the overall space of the rack, which cannot effectively improve the heat dissipation efficiency. Moreover, the rack management lacks an overall control and management strategy.

Therefore, it has become an urgent problem how to design a rack server system with a central control and management mechanism, so as to achieve a more effective management and heat dissipation.

### SUMMARY

Therefore, an aspect of the disclosure provides a rack server system. The rack server system includes a plurality of server modules, a plurality of fan modules, a rack management network and a rack management module. Each of the server modules includes a baseboard management controller (BMC) to monitor and manage a work status of the corresponding server module. Each of the fan modules includes a plurality of fans. The rack management, network is connected to the BMC of each server module. The rack management module receives the work status from the BMC of each server module through the rack management network to control and manage the server modules and to control speed of the fan modules according to the work status.

### BRIEF DESCRIPTION OF THE DRAWINGS

The following as well as other objectives, features, advantages and embodiments of the present invention can be more fully understood, with reference made to the accompanying drawings as follows:

FIG. 1 is a block diagram of a rack server system according to an embodiment of the disclosure;

FIG. 2 is a block diagram of a server module in FIG. 1 according to an embodiment of the disclosure;

FIG. 3 is a block diagram of a fan module in FIG. 1 according to an embodiment of the disclosure; and

FIG. 4 is a block diagram of a container server architecture according to an embodiment of the disclosure.

### DETAILED DESCRIPTION

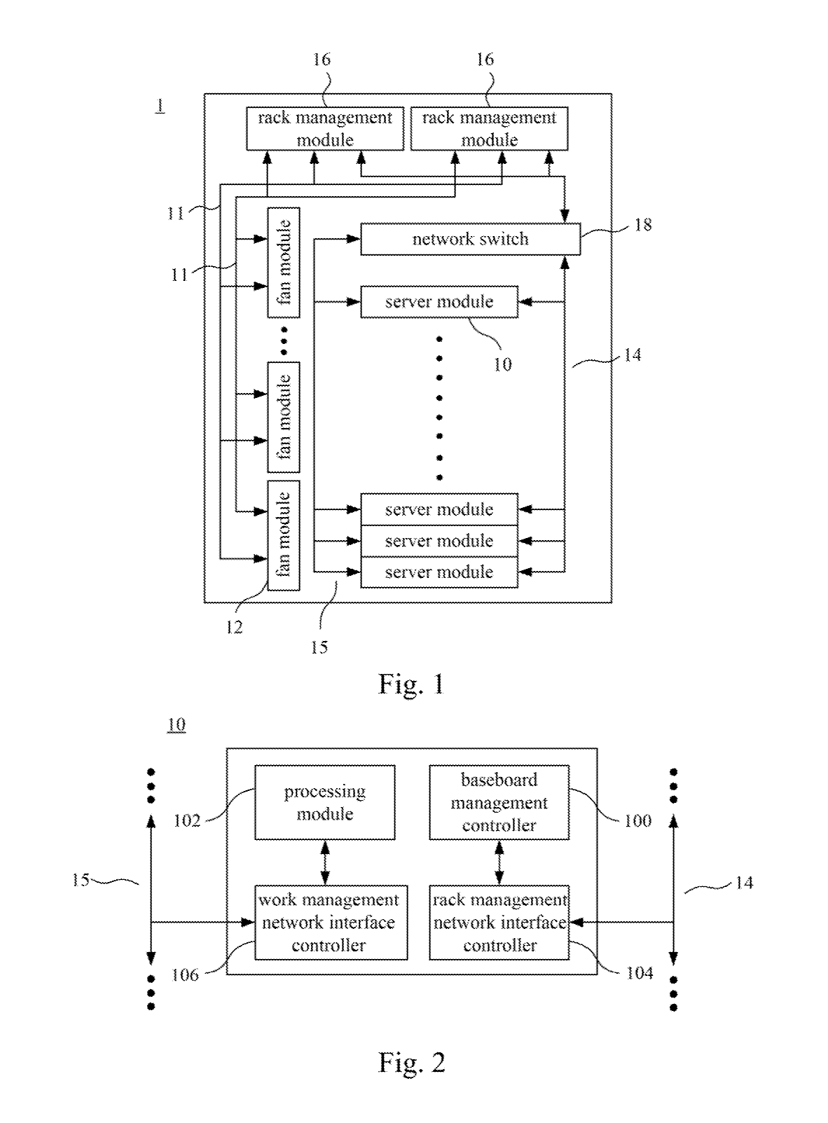

Referring to FIG. 1, FIG. 1 is a block diagram of a rack server system 1 according to an embodiment of the disclosure. The rack server system 1 includes server modules 10, fan modules 12, a rack management network 14 and rack management modules 16.

The number of the server modules 10 is determined depending on the actual application. Referring to FIG. 2, FIG. 2 is a block diagram of a server module 10 according to an embodiment of the disclosure. Each server module 10 includes a baseboard management controller (BMC) 100 and a processing module 102. The BMC 100 is used to monitor and manage a work status of the server module 10, and the processing module 102 is used to perform data transfer and processing. Each server module 10 further includes a rack management network interface controller (NIC) 104 and a work management NIC 106. The BMC 100 may be connected to the rack management network 14 through the rack management NIC 104, and the processing module 102 is connected to a work management network 15 of the rack server system 1 through the work management NIC 106.

In an embodiment, the rack management network 14 and the work management network 15 are two independent networks. The rack server system 1 may further include a network switch 18, so that the rack management network 14 and the work management network 15 are connected to the network switch. 18 to respectively process packets over the respective network. The processing module 102 may be firstly connected to the work management network 15 and the network switch 18 through the work management NIC 106 and then connected to the external Ethernet network, so as to perform the data transfer, receiving and processing. The rack management module 16 may be communicated with the BMC 100 of each server module 10 by the rack management NIC 106 through the network switch 18 and the rack management network 14.

In an embodiment, the rack management module 16 is a BMC chip. Moreover, in an embodiment, the number of the rack management modules 16 may be greater than two and they are redundant to each other. That is, at the same time, the rack server system 1 may have only one rack management module 16 in operation, and when the rack management module 16 in operation is damaged or down and cannot operate, the other redundant rack management module 16 takes its place and communicates with the server modules 10.

In an embodiment, the rack management network 14 is an intelligent platform management interface (IPMI). The rack management module 16 may be communicated with the BMC 100 of each server module 10 under the command for the interface through the rack management network 14 so as to acquire the work status of each server module 10. For example, the BMC 100 can access the sensor (not shown) of the corresponding server module 10, so as to acquire the work status including such as a temperature parameter, a voltage parameter, a power consumption parameter or any permutation and combination thereof. After acquiring the work status of each server module 10, the rack management module 16 may control and manage the server module 10 according to the work status.

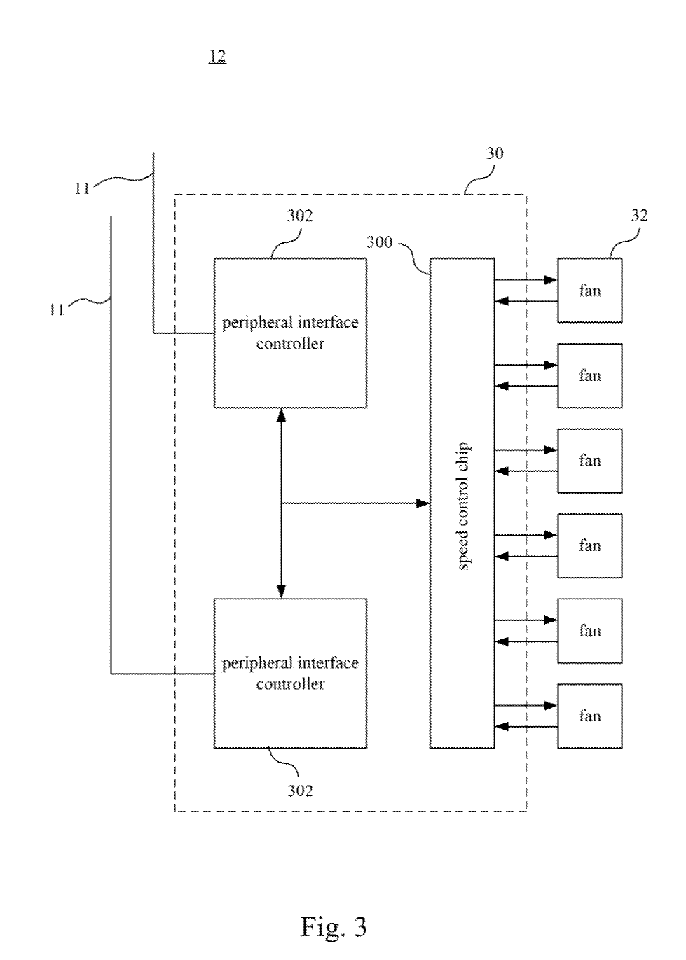

For example, the rack management module 16 may control and manage the fan modules 12 according to the work status. Referring to both FIG. 1 and FIG. 3 at the same time. FIG. 3 is a block diagram of the fan module 12 according to an embodiment of the disclosure. Each of the fan modules 12 includes a fan control board 30 and fans 32. The fan control board 30 includes a speed control chip 300 and a peripheral interface controller 302. The rack management module 16 is communicated with the fan control board 30 through the communication port 11, so as to control the speed control chip 300 through the peripheral interface controller 302 and further control the speed of the fan 32. In an embodiment, the communication port 11 includes a primary communication port and a standby communication port, which have the redundant functions, so that when one port fails to operate, the other port takes its place to achieve the communication between the rack management module 16 and the fan control board 30.

The peripheral interface controller 302 can perform an initialization process on the speed control chip 300 when the rack server system 1 starts operating. In an embodiment, the number of the peripheral interface controllers 302 may be two, and they perform the initialization process on the speed control chip 300 at a specific time interval sequentially. In an embodiment, the two peripheral interface controllers 302 are redundant to each other.

The rack management module 16 can generate a fan read command, so that the peripheral interface controller 302 reads a speed value of the fan 32 from the speed control chip 300 and transfers the speed value to the rack management module 16. Each fan module 12 includes an identification number. The rack management module 16 can acquire the work status (e.g. the temperature) of the server modules 10 and the speed value of the fan 32 of the fan modules 12 from the BMC 100 of the server module 10 through the rack management network 14 in the above-mentioned manner, and then respectively control the speed of the fan modules 12 through the identification number. In an embodiment, the rack management module 16 can store a fan speed table therein, so as to adjust the speed according to information such as a temperature status and a current speed of the fan after reading the fan speed table.

Therefore, the rack management module 16 can acquire the operation status of the overall rack server system 1 according to the work status of the server module 10, for example, the overall temperature distribution. Then the rack management module 16 controls the speed of the fan modules 12 under the consideration of the entire system, thereby achieving the purpose of the central control and management.

On the other hand, the rack management module 16 can control a power up process of the server module 10, so as to avoid an excessive instantaneous voltage or current caused by the server modules 10 actuated altogether when the entire rack server system 1 is just actuated or the rack server system 1 is powered on after a blackout. In an embodiment, after the initialization of the rack management module 16, the rack management network address of the BMC 100 of the server modules 10 can be captured, so as to randomly generate a plurality of delay times according to the rack management network address. Therefore, the BMC 100 of the server modules 10 can sequentially actuate the power of the server modules 10 according to these delay times. For example, the rack management module 16 can generate the delay times on the basis of one bit of the rack management network address of the BMC 100, so that these server modules 10 are actuated after different delay times, thereby avoiding the simultaneous actuation.

In another embodiment, after initialization, the rack management module 16 can capture a media access control address of the BMC 100 of the server modules 10, so as to randomly generate a plurality of delay times according to the media access control address. Therefore, the BMC 100 of the server modules 10 can actuate the power of the server modules 10 according to the delay times sequentially.

In still another embodiment, instead of using the rack management module 16 to make the central control and management, the BMC 100 of the server modules 10 randomly generates the delay times according to the rack management network address or the media access control address, so that the BMC 100 actuates the power of the corresponding server module 10 according to the delay time.

Therefore, the rack management module 16 can decide the power-on sequence of the server modules 10 in a manner of central control and management, so that an excessive current or voltage caused by the simultaneous actuation of the power of the overall rack server system 1 will not occur.

In another embodiment, the rack management module 16 can receive an input command generated by a user from one control terminal (not shown) to control and manage the server modules 10. For example, the power-up of the server modules 10 mentioned above can be conducted by receiving an input command generated by the user from the control terminal and then generating a power-on control signal. The rack management module 16 outputs the power-on control signal to the BMC 100 of one server module 10, so that the BMC 100 randomly actuates the server modules 10. Moreover, the rack management module 16 can also control the speed of the fan module 12 according to the input command generated by the user from the control terminal.

The rack server system 1 in this embodiment can have independent fan modules 12 and control and manage the server modules 10 and adjust the speed of the fan modules 12 according to the work status of the server modules 10 captured by the rack management module 16 through the rack management network 14, thereby making control according to the overall operation status of the rack server system 1 and achieving the effect of the central control and management.

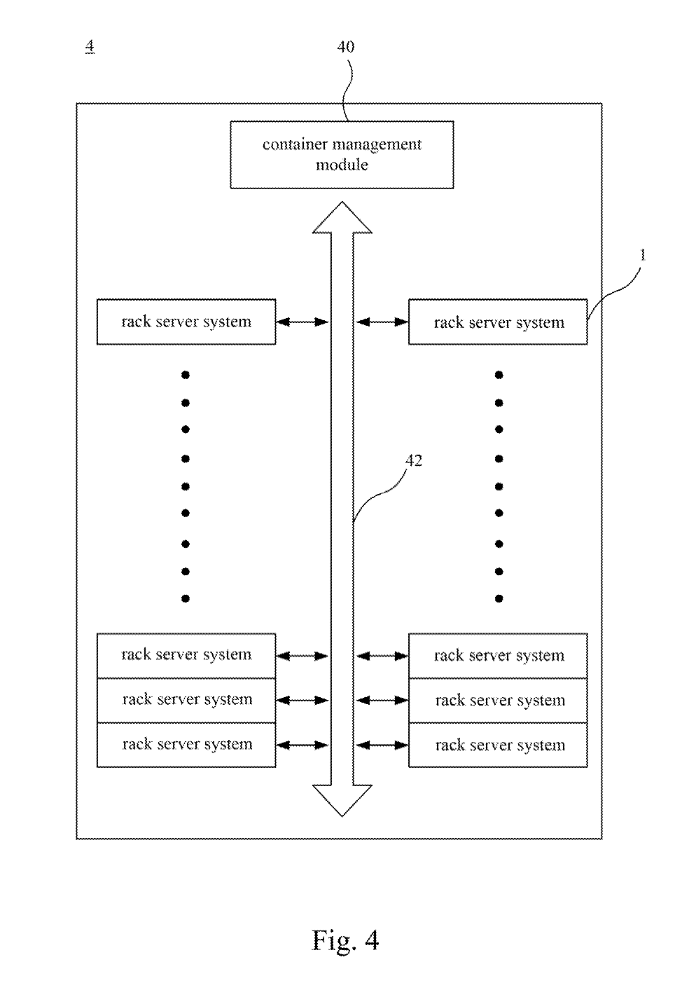

In still another embodiment, the rack server system 1 may be located in a container server architecture. Referring to FIG. 4, FIG. 4 is a block diagram of a container server architecture 4 according to an embodiment of the disclosure.

The container server architecture 4 substantially includes a plurality of rack server systems 1. The container server architecture 4 further includes a container management module 40 connected to the rack management modules 16 (not shown in FIG. 4) of the rack server systems 1 through a management network 42. Actually, the rack management network 14 in FIG. 1 is a part of the management network 42. Through the management network 42, the rack management module 16 can transfer the work status captured from the server modules 10 to the container management module 40 and then the container management module 40 makes the control and management and performs processing on the work status information. A control command is transferred to the rack management module 16 of the rack server systems 1 according to the processing result. The rack server systems 1 then control and manage the server modules 10 and control the speed of the fan modules 12 according to the control command. Therefore, after being processed by the high-level container management module 40, the container server architecture 4 that can accommodate many rack server systems 1 can have an overall control and management and heat dissipation processing mechanism.

Although the present invention has been described with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A rack server system, comprising:
a plurality of server modules, each comprising a baseboard management controller to monitor and manage a work status of a corresponding server module;
a plurality of fan modules, each comprising a plurality of fans;
a rack management network connected to the baseboard management controller of each server module; and
a rack management module receiving the work status from the baseboard management controller of each server module through the rack management network to control and manage the server modules and to control speed of the fan modules according to the work status.

2. The rack server system of claim 1, wherein the number of the rack management modules is at least two and they are redundant to each other.

3. The rack server system of claim 1, wherein each of the server modules further comprises a processing module connected to an external Ethernet network through a work management network independent from the rack management network.

4. The rack server system of claim 3, wherein each of the server modules further comprises a rack management network interface controller and a work management network interface controller, so that the rack management module is connected to the rack management network through the rack management network interface controller, and the processing module is connected to the work management network through the work management network interface controller.

5. The rack server system of claim 1, wherein the rack management module is a baseboard management controller chip.

6. The rack server system of claim 1, wherein the rack server system is located in a container server architecture, the container server architecture further comprises a container management module connected to the rack management module through the rack management network, and the rack management module transfers the work status to the container management module, so as to control and manage the server modules and to control the speed of the fan modules according to a processing result of the container is management module.

7. The rack server system of claim 1, wherein the fan module further comprises a fan control board, and the rack management module is communicated with the fan control board through a primary communication port or a standby communication port to further control the fans.

8. The rack server system of claim 7, wherein the fan control board of each fan module comprises a speed control chip and at least a peripheral interface controller, so that the rack management module controls the speed control chip through the peripheral interface controller and further controls the corresponding one of the fan modules.

9. The rack server system of claim 8, wherein the peripheral interface controller performs an initialization process on the speed control chip sequentially at a specific time interval.

10. The rack server system of claim 8, wherein the number of the peripheral interface controllers is two and they are redundant to each other, so that one of the peripheral interface controllers reads a speed value of the fan modules from the speed control chip according to a fan read command of the rack management module and transfers the speed value to the rack management module.

11. The rack server system of claim 1, wherein each of the fan modules comprises an identification number, so that the rack management module controls the speed of each of the fan modules through the identification number respectively.

12. The rack server system of claim 1, wherein the rack management module further controls a power up process of the server modules.

13. The rack server system of claim 12, wherein the rack management module retrieves a rack management network address of the baseboard management controller of the server modules after an initialization process to randomly generate a plurality of delay times according to the rack management network address, so that the baseboard management controller of the server modules sequentially actuates a power of the server modules according to the delay times.

14. The rack server system of claim 12, wherein the rack management module retrieves a media access control address of the baseboard management controller of the server modules after an initialization process to randomly generate a plurality of delay times according to the media access control address, so that the baseboard management controller of the server modules sequentially actuates power according to the delay times.

15. The rack server system of claim 1, wherein the baseboard management controller of each server module randomly generates a delay time according to a rack management network address of the baseboard management controller, so that the baseboard management controller actuates a power of the corresponding server module according to the delay time.

16. The rack server system of claim 1, wherein the baseboard management controller of each server module randomly generates a delay time according to a media access control address of the baseboard management controller, so that the baseboard management controller actuates a power of the corresponding server module according to the delay time.

17. The rack server system of claim 1, wherein the rack management network is an intelligent platform management interface (IPMI).

18. The rack server system of claim 1, wherein the rack management module controls and manages each of the server modules according to an input command and controls the speed of the fan modules.

19. The rack server system of claim 18, wherein the baseboard management controller of each of the server modules receives a power-on control signal and then is actuated, and the rack management module outputs the power-on control signal according to the input command.

20. The rack server system of claim 19, wherein the rack management module outputs the power-on control signal to the baseboard management controller of one of the server modules, so that the baseboard management controller randomly actuates the server modules.
